(19) United States
(12) Patent Application Publication
(10) Pub. No.: US 2024/0075324 A1
(43) Pub. Date: Mar. 7, 2024

(54) Lanyard Connection Device with Quick Release Gate and Built-In Length Adjuster

(71) Applicant: Basecamp Innovations Ltd., Invermere (CA)

(72) Inventor: Kirk M. Mauthner, Invermere (CA)

(21) Appl. No.: 17/903,207

(22) Filed: Sep. 6, 2022

(51) Int. Cl. A62B 35/00

(52) U.S. Cl. CPC A62B 35/0075

(57) ABSTRACT

A lanyard connection device combines, in a singular piece of hardware, a movable gate for opening and closing a load-receiving eye of the device, a lock for holding the gate closed, a user-actuated quick release operably associated with the lock, and a length adjuster configured for engagement with a lanyard at an intermediate location between anchoring and tail ends thereof. The adjuster is manipulatable between a holding state preventing displacement between the device and lanyard, and an adjustment state releasing the hold to enable user-adjustment of the lanyard's working length. To prevent inadvertent opening of the eye, the quick release comprises multiple actuators that require simultaneous actuation thereof to release the lock from the locking position. The adjuster features a slidable bollard that receives wrapped engagement of the lanyard and, in the holding state, clamps the wrapped segment thereof against a neighboring clamping surface.

### FIELD OF THE INVENTION

The present invention relates to hardware for personal retention lanyards used in helicopters to safely tether an occupant thereof to an anchor point of the aircraft via an occupant-worn belt or harness.

### BACKGROUND

Military and/or SWAT operators use tactical position and retention lanyards to secure themselves to helicopter platforms where seatbelts are either not available, or not an option for the given operation at hand. Most helicopter lanyards employ multiple pieces of separate hardware: a snap hook at one end of the lanyard to connect to an anchor point in the helicopter, a connection device couplable to an operator's harness or waist belt to connect the lanyard to the operator, and a separate length adjuster operable to shorten/lengthen a working length of the lanyard between the anchor point and the connection device coupled to the operator's belt or harness. In some cases, the hardware includes a quick release mechanism that can be used by the operator to quickly release themselves from the lanyard.

Conventionally, the separate length adjuster resides at a notably spaced distance from the connection to the operator's harness or belt, a result of which is that length adjustment of the lanyard requires the operator to turn their focus away from an attentive surveillance of the outside environment, in order to reach back toward the anchor point in order to access and manipulated the length adjuster. Existing quick release mechanisms may also risk inadvertent actuation thereof if snagged, knocked or hung up on clothing or some obstruction.

Accordingly, there is a need for improved hardware useable in the context of personal retention lanyards to address these shortcomings of the prior art.

### SUMMARY OF THE INVENTION

According to a first aspect of the invention, there is provided a lanyard connection device for combined use with a lanyard having an anchoring end equipped with a coupler for anchored attachment to an anchor point, and an opposing tail end, said connection device comprising a singular assembly whose components comprise:
a frame;
a gate movably supported on the frame and movable relative thereto between a closed position in which said gate cooperates with at least one other of the components to collectively form a closed boundary around an eye space, and an open position that opens up a gap in said closed boundary to enable insertion of a securement member of an intended load into the eye space such that reclosure of the gate secures said intended load to the device;
a lock movably supported on the frame and movable relative thereto between a locking position engaging and holding the gate in the closed position, and an unlocking position disengaged form the gate to allow movement thereof to the open position;
a quick release operably associated with the lock in a manner normally holding the lock in the locking position, absent user-actuation of said quick-release; and
a length adjuster configured for engagement with the lanyard at an intermediate region thereof between the anchoring and tail ends thereof, and manipulatable between a holding state imparting a hold between the device and the lanyard to prevent relative displacement therebetween, and an adjustment state releasing said hold to allow said displacement, thereby enabling adjustment of a working length of the lanyard between the anchoring end thereof and the device.

In instances where the intended load is a belt or harness wearing operator, and owing to the novel incorporation of the length adjuster into the same unit that connects to the load via an openable/closable eye, the operator need not divert their attention away from a surveilled environment in order to reach for and manipulated a separate length adjuster situated remotely of their belt or harness.

Preferably the lock comprises a rocker arm pivotably mounted to the frame and pivotable between said locking and unlocking positions.

Preferably the quick release comprises a slider slidably coupled to the frame and displaceable back and forth relative thereto along a slide path from a default position holding the lock in the locking position, toward a release position.

Preferably a portion of the lock is constrained to the slider for movement therewith back and forth along the slide path.

More preferably, one end of the rocker arm is constrained to the slider for movement therewith back and forth along the slide path.

Preferably the quick release comprises multiple actuators that require simultaneous actuation to release the lock from the locking position.

Preferably the multiple actuators are configured to require performance of multiple and distinct actuating movements thereon to actuate the quick release.

Preferably said multiple and distinct actuating movements comprise pressing and sliding movements.

Preferably said multiple actuators comprise two actuators disposed at opposing sides of the device.

Preferably said two actuators comprise two push-button actuators that require simultaneous depression toward one another to release the lock from the locking position.

Preferably the two push-button actuators reside at opposing sides of the slider in normally undepressed positions that lock the slider in the default position, and are depressible to depressed positions allowing displacement of the slider from the default position toward the release position.

Preferably the length adjuster is configured to automatically engage itself in the holding state under application of a pulling load to the device at the eye space thereof.

Preferably the length adjuster comprises a slidable bollard slidably coupled to the frame and displaceable back and forth relative thereto between a holding position clamping the intermediate region of the lanyard against a stationary feature on the frame to impart said hold, and an adjustment position withdrawn further away from said stationary feature to release said hold.

Preferably the sliding bollard is slidable back and forth on a bollard slide path that runs in a longitudinal direction of the device in which the sliding bollard and the bollard slide path are also spaced from the eye space, and the stationary feature of the frame resides near an end of the bollard slide path furthest from the eye space, such that exertion of a longitudinal pulling load on the device at the eye space thereof in a pulling direction away from the sliding bollard acts to automatically clamp the lanyard against the stationary feature.

Preferably there is a lanyard opening for accommodating routing of the lanyard to and around the sliding bollard, and the lanyard opening and the eye space reside distally opposite one another in said longitudinal direction of the device.

Preferably the length adjuster is configured to intentionally allow limited slippage between the device and the lanyard under application of a shock load that exceeds a predetermined limit.

According to a second aspect of the invention, there is provided a connection device for connecting a load to a flexible line, said device comprising a singular assembly whose components comprise:
a frame;
a line engagement component for receiving said flexible line and holding the device thereto;
a gate movably supported on the frame and movable relative thereto between a closed position in which said gate cooperates with at least one other of the components to collectively form a closed boundary around an eye space, and an open position that opens up a gap in said closed boundary to enable insertion of a securement member of an intended load into the eye space such that reclosure of the gate secures said intended load to the device;
a lock movably supported on the frame and movable relative thereto between a locking position engaging and holding the gate in the closed position, and an unlocking position disengaged from the gate to allow movement thereof to the open position; and
a quick release operably associated with the lock in a manner normally holding the lock in the locking position, absent user-actuation of said quick-release;
wherein the quick release comprises multiple actuators that require simultaneous actuation thereof to release the lock from the locking position.

By requiring user-input on multiple actuators in order to operate the quick release and thereby disengage the lock, the possibility of inadvertent actuation of the quick-release by snag, impact or hang-up on the device by some object is greatly reduced.

During some instances of use, the flexible line, which may be a lanyard, has an anchoring end attached to an anchoring point on a craft.

In some instances, said craft may be an aircraft.

In some instances, said aircraft may be a helicopter.

During some instances of use, said securement member is embodied by or attached to a user-wearable belt or harness, such that the intended load is a wearer of said belt or harness.

According to a third aspect of the invention, there is provided a length adjustment device for combined use with a lanyard having an anchoring end equipped with a coupler for anchored attachment to an anchor point, and an opposing tail end, said length adjustment device comprising:
a frame; and
a slidable bollard for wrapped engagement thereof by the lanyard at an intermediate region thereof between the anchoring and tail ends of said lanyard, said slidable bollard being slidably coupled to the frame and displaceable back and forth relative thereto between a holding position clamping the intermediate region of the lanyard against a stationary feature on the frame to impart a hold between the device and the lanyard to prevent relative displacement therebetween, and an adjustment position withdrawn further away from said stationary feature to release said hold and allow said displacement, thereby enabling adjustment of a working length of the lanyard between the anchoring end thereof and the device.

This novel design of a length adjustment mechanism is particularly effective when integrated into a load connection device, but also may be employed on its own, or integrated into another type of hardware.

### BRIEF DESCRIPTION OF THE DRAWINGS

A preferred but non-limiting embodiment of the invention will now be described in conjunction with the accompanying drawings in which:

FIG. 1 is a perspective view of a novel lanyard connection device of the present invention from a front side thereof, with an openable/closable eye of the device in a closed state and a built-in length adjuster of the device in a holding position.

FIG. 2 is another perspective view of the connection device of FIG. 1 from an opposing rear side thereof.

FIG. 3 is a front elevational view of the connection device of FIG. 1.

FIG. 4 is a rear elevational view of the connection device of FIG. 1.

FIG. 5 is a cross-sectional view of the connection device of FIG. 1 in a plane denoted by line A-A of FIG. 6.

FIG. 6 is a cross-sectional view of the connection device in a plane denoted by line B-B of FIG. 3.

FIG. 7 is a cross-sectional view of the connection device in a plane denoted by line C-C of FIG. 3.

FIG. 8 is a rear elevational view like FIG. 4, but with the openable/closeable eye in an open state and the length adjuster in an adjustment position.

FIG. 9 is a cross-sectional view of the connection device of FIG. 8 in the same cross-sectional plane as FIG. 5, but with the openable/closeable eye in an open state and the length adjuster in an adjustment position.

FIG. 10 is another cross-sectional view of the connection device of FIG. 5 in the same cross-sectional plane, but illustrating use of the device on a lanyard to secure a load thereto, while maintaining the lanyard at a substantially fixed working length.

FIG. 11 is another cross-sectional view of the connection device of FIG. 10 in the same cross-sectional plane, but illustrating release of the load via opening of the eye of the device, as well as permitted adjustment of the lanyard's working length by movement of the length adjuster from its holding position to its adjustment position.

### DETAILED DESCRIPTION

The drawings show a novel lanyard connection device 10 of the present invention that is intended for cooperative use with a lanyard 100 that has an anchoring end 102, and an opposing tail end 104, as shown in FIGS. 10-11. In use of the lanyard 100, for example to tether an operator of the device 10 to an anchor point 106 in a helicopter cabin, the anchoring end 102 is secured to said anchor point 106 by a snap hook or other coupler 108 that is affixed to the lanyard at the anchoring end 102 thereof. The device 10 is engaged with the lanyard 100 somewhere along an intermediate region thereof between the coupler-equipped anchoring end 102 and the opposing tail end 104, which is left free in an unanchored state of unattached relation to the helicopter, or any other craft or structure to which the anchoring end 102 is securely anchored by the attached coupler 106.

As described in more detail below, attachment of the device 10 to the lanyard 100 relies on wrapped embrace of an internal component of the device 10 by the lanyard 100 somewhere along the intermediate region thereof. This particular point of engagement between the device 10 and the lanyard can be adjusted, via operation of an integrated length adjuster of the device 10, to change an effective working length L_{W} of the lanyard. The working length L_{W} refers to a partial length of the lanyard measured from the attachment end 102 thereof to the device 10. At any given time, the lanyard can be considered to comprise two segments, a load segment 100A spanning from the attachment end 102 to the device 10, and therefore defining the effective working length L_{W} of the lanyard, and a tail segment′ 1006 spanning from the device 10 to the tail end 104 of the lanyard 100. The relative lengths of these two segments 100A, 100B can be adjusted when the length adjuster is in a state permitted such adjustment. In such state of permitted length adjustment, pulling of the tail end 104 or tail segment 100B of lanyard draws more of the load segment 100A into the device 10, thus decreasing the effective working length L_{W} of the lanyard 100. On the other hand, pulling of the load segment 100A of the lanyard 100 draws more of the tail segment 100B into the device 10 and withdraws more of the load segment 100A therefrom, and thus increases the effective working length L_{W}. In FIGS. 10 and 11, where the device 10 and lanyard 100 are shown in combination, the device 10 is shown at exaggerated scale relative to the diameter of the lanyard in the interest of maximizing the visibility of the device's componentry and features in a manner substantially unobscured by the lanyard's routed pathway through the device 10. In practice, the device 10 will typically be of smaller relative proportion to the lanyard diameter, with the lanyard's routed path through the device thus occupying a more substantial amount of the available internal space of the device 10.

The device 10 is embodied in a singular unit assembled from a plurality of components, including a frame 12, a gate 14, a lock 16, a quick release 18 and a length adjuster 20. The frame, whether embodied as a subassembly of multiple parts, like in the illustrated embodiment, or a singular part, serves to as a base on which the other components are movably supported to serve the various functional purposes described herein. The frame 12 thus defines a reference frame relative to which the locations and movements of the other parts can be described, but the particular shape of the frame may vary from that shown and described.

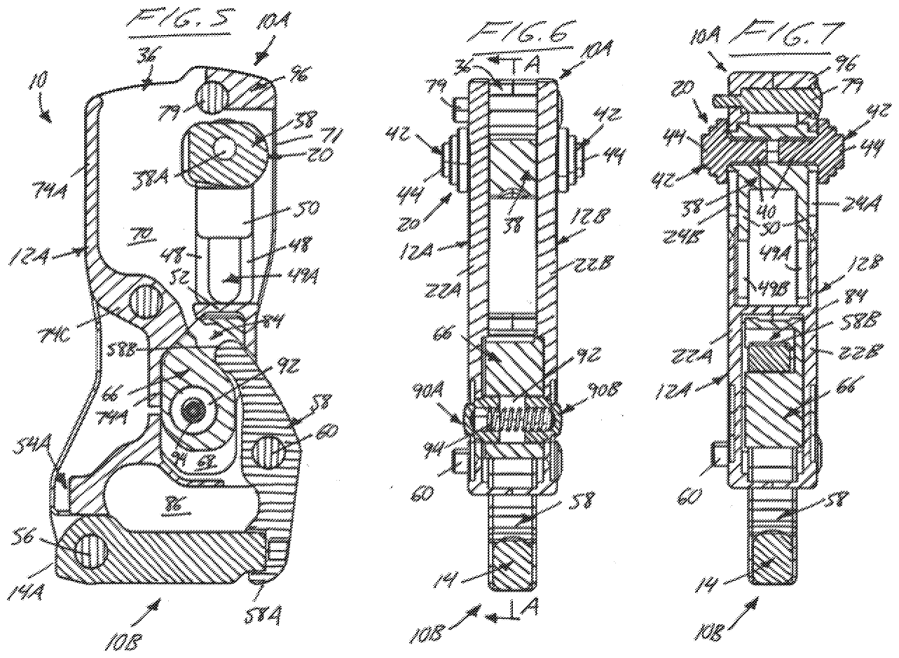

In the illustrated example, the frame 12 is composed of two frame bodies 12A, 12B of substantially mirrored relationship and structure to one another across a midplane of the device, in which the view of FIG. 5 is cross-sectioned. Each frame half 12A, 12B has an outer wall 22A, 22B that defines a respective outer face of the overall device 10 on a respective front or rear side of said midplane at an offset distance outward therefrom, whereby an interior space of the device 10 is bound between these outer walls 22A, 22B. In this example where the two frame bodies are of substantially equal size and symmetric relationship across the midplane of the device, each body constitutes a respective half of the frame, though this need not necessarily be the case. The two frame bodies need not necessarily be of matching shape and size to one another to enable assembly thereof together in a similar manner bounding an interior space of the device 10 between their outer walls.

The device 10 has a proximal end 10A and an opposing distal end 10B, which are spaced apart from one another in a longitudinal direction denoted by a longitudinal reference axis A_{R}, which is shown in FIG. 4 and coincides with cross-sectional reference line A-A of FIG. 6. In the illustrated orientation of the device, the proximal and distal ends 10A, 10B denote the top and bottom ends thereof respectively, and it will be appreciated that any reference herein to top, bottom, upper, lower, etc. is used in reference to the illustrated orientation, and does not refer to any particular orientation that the device must occupy during use thereof. Near the proximal end 10A of the device 10, the outer walls 22A, 22B of the device feature a pair of matching and aligned adjuster slots 24A, 24B therein, each of which is elongated in the longitudinal direction, and thus has a proximal slot end 26 nearest to the proximal end 10A of the device 10 and a distal slot end 28 of the adjuster slot nearer to the distal end 10A of the device 10. Near the distal end 10B of the device 10, the outer walls 22A, 22B also feature a pair of matching and aligned release slots 30A, 30B therein, each of which is also elongated in the longitudinal direction, and thus likewise has a proximal slot end 32 nearest to the proximal end 10A of the device 10 and a distal slot end 34 nearer to the distal end 10A of the device 10. The adjuster slots 24A, 24B are notably spaced from the release slots 30A, 30B in the longitudinal direction of the device, such that their lengths do not overlap one another in the longitudinal direction of the device. Such spacing apart of the quick release 18 that is installed in the release slots 30A, 30B from the adjuster 20 that is installed in the adjuster slots 24A, 24B helps ensure that manual manipulation of the length adjuster does not result in inadvertent actuation of the quick release.

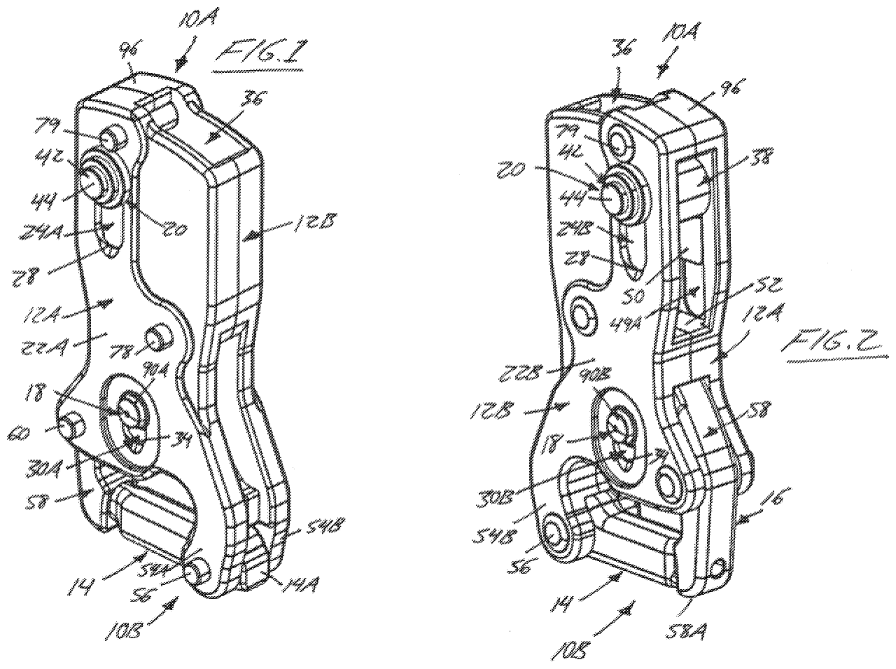

Referring to FIGS. 1 and 2, at the proximal end 10A of the device, a lanyard opening 36 is delimited between terminal edges of the two outer walls 22A, 22B of the frame 10. This lanyard opening 36 opens longitudinally into the interior space of the device bound between the two outer walls 22A, 22B. This lanyard opening 36 accommodates routing of the lanyard 100 into and back out of the interior of the device 10 during installation of the device onto the lanyard 100. Once so installed, both the load segment 100A, and tail segment 100B of the lanyard 100 thus pass through this same lanyard opening 36 at the proximal end 10A of the device, as can be seen in FIGS. 10 and 11.

The length adjuster 20 features a slidable but non-rotatable bollard 38 housed in the interior of the device 10 between the outer walls 22A, 22B thereof in alignment with the two adjuster slots 24A, 24B therein. The bollard 38 features a through-bore 38A therein whose open ends align with the two adjuster slots 24A, 24B, and each of which receives a stud 40 of a respective end cap 42 of the bollard 38 through the respective adjuster slot 24A, 24B. An enlarged head 44 of each end cap 42 is greater in outermost diameter than the stud 40 to which it is affixed, is also wider than the respective adjuster slot 24A, 24B, and resides outside the respective outer wall 22A, 22B of the device. Instead of a through bore, the studs of the end caps 42 may be received in respective blind holes at the opposing front and rear sides of the bollard 38.

The externally located heads 44 of the end caps 42 serve as accessible exterior grips by which the bollard assembly can be manually gripped, and slid back and forth along the adjuster slots 24A, 24B by an operator of the device 10. In the illustrated example, the head 44 of each end cap 42 is characterized by a dumbbell-like stepped-diameter profile, have a smallest diameter at its outermost end furthest from the respective outer wall 22A, 22B of the frame 10, with two step-wise increases in diameter moving toward said respective outer wall. This creates annular shoulders around the outside of each end cap 42 that the operator can push on with confident grip to displace the bollard assembly along the adjuster slots 24A, 24B when adjustment of the lanyard's working length L_{W} is desired, as described in more detail further below. The inside of each outer wall 22A, 22B has recessed ledges 48 therein bordering the longitudinal sides of the respective adjuster slot 24A, 24B of the outer wall 22A, 22B. From the distal end 28 of each adjuster slot 24A, 24B, the recessed ledges 48 open into a larger recess 49A, 49B, which is a continuous extension of the adjuster slot 24A, 24B, but doesn't penetrate the outer wall 22A, 22B like the adjuster slot, and is instead only recessed into the inside of the outer wall, like the recessed ledges 48 that neighbor the slot 24A, 24B.

The bollard 38 has two rectangular slide tabs 50 that are situated at the opposing front and rear sides of the bollard so as to respectively neighbour the two outer walls 22A, 22B in parallel fashion thereto at the inside thereof, specifically in positions riding within the recessed depth of the ledges 48 and extension recess 49, and spanning a substantially full width thereof. By occupying this full width, these slide tabs 50, and the bollard 38 to which they are integrally or otherwise affixed, are prevented from rotating as they slide back and forth along the adjuster slots 24A, 24B and extension recess 49. The bollard 38 is therefore constrained to linear displacement along the adjustment slots 24A, 24B, without any rotation. The slide tabs 50 project distally from the remainder of the bollard 38, and thus also serve as stops to limit the amount of distal travel the bollard 38 can move in the longitudinal direction toward the distal end 10B of the device 10. To provide a robust stop, the frame 10 features a corresponding stop wall 52 that spans between the inside surfaces of the two outer walls 22A, 22B at the terminal distal ends of the extension recesses 49 to ensure robust stopping of the slide tabs 50 thereat.

At the distal end 10B of the device 10, each frame body 12A, 12B is characterized by an extended jaw 54A, 54B that resides at a first lateral side of the device 10, and is of distally protruding relation to the rest of the frame body. The extended jaws 54A, 54B of the two frame bodies 12A, 12B are of matching and aligned relationship to one another. The gate 14 is an elongated member having a pivot end 14A that is received between the jaws 54A, 54B of the two frame bodies 12A, 12B and is pivotably supported therebetween by a first pivot pin 56 penetrating collectively through the two jaws 54A, 54B and the gate 14. An opposing free end 14B of the gate is thus swingable about a first pivot axis that is defined by the first pivot pin 56 and lies orthogonally of the planes occupied by the device's slotted outer walls 22A, 22B. The aforementioned longitudinal reference axis A_{R} lies parallel to these planes, and perpendicular to the gate's pivot axis.

The lock 16 is composed of a rocker arm 58 that is likewise pivotably coupled to the frame 12 by a second pivot pin 60 that also penetrates collectively through the two frame bodies 12A, 12B to pivotably carry the rocker arm 58 therebetween on a second pivot axis that is parallel to the first pivot axis. This second pivot pin 60 resides at a second lateral side of the frame 12 of opposing relation to the first lateral side where the jaws 54A, 54B carry the pivotable gate 14. The second pivot pin 60 is located not on a protruding jaw of the frame 12 like the first pivot pin 56, but instead resides at a distal corner shoulder 62 of the frame 12 that is of lesser distal reach than the protruding jaws 54A, 54B at the other lateral side of the frame 12. In the longitudinal direction, the second pivot pin 60 carrying the rocker arm 58 of the lock 16 is thus closer to the release slots 30A, 30B than the first pivot pin 56 that carries the movable gate 14.

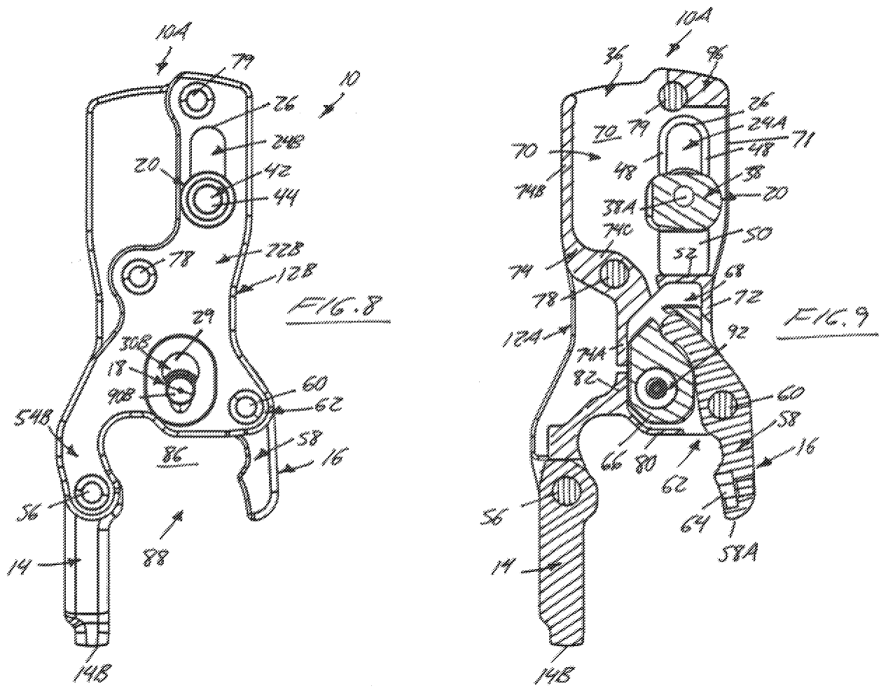

The second pivot pin 60 penetrates a mid-region of the rocker arm 58 that resides between the outer walls 22A, 22B of the frame bodies 12A, 12B at the distal corner shoulder 62 thereof. From this pivotally pinned mid-region, a distal portion of the rocker arm 58 protrudes distally out from between the frame bodies 12A, 12B to a distal end 58A of the rocker arm 58. Near this distal end 58A, the rocker arm has a gate cavity 64 therein that resides at a side thereof that faces toward the jaws 54A, 54B, and is shaped to matingly receive and hold the free end 14B of the gate 14 inside this cavity 64 when the gate 14 and the rocker arm 58 are in their closed and locking positions, respectively, as shown in FIGS. 1-7 and 10. A proximal portion of the rocker arm reaches proximally from the second pivot pin 60 further into the interior space of the device bound between the outer walls 22A, 22B.

The quick release 18 features an internal slider 66 residing within the interior space of the device near the distal corner shoulder 62 and between the two release slots 30A, 30B in the outer walls 22A, 22B. The slider 66 is contained to a bounded distal cavity 68 of the device's interior space, whereby sliding limits on the slider's movement is not constrained solely by the release slots 30A, 30B, but also by the size and shape of this distal cavity 68. A proximal end of this distal cavity 68 is bound by the aforementioned stop wall 52, on an opposing proximal side of which is a separate proximal cavity 70 of the device's interior space, which contains the slidable bollard 38 and accommodates wrapped routing of the lanyard 100 therearound. Depending distally from the stop wall 52 at a laterally outer end thereof is a proximal exterior wall 72 of the distal cavity 68, which is a relatively short boundary wall spanning only a partial fraction of a laterally exterior side of the distal cavity 68. Below the proximal exterior wall 72, this laterally exterior side of the distal cavity 68 is left open to accommodate rocking movement of the lock's rocker arm 58. As shown in the cross-sectional views, an S-shaped boundary wall 74 of the device's interior space resides across the distal cavity 68 from the proximal side exterior wall 72. This S-shaped wall 74 has a distal segment 74A that closes off an opposing interior side of the distal cavity 68. A proximal segment 74B of this S-shaped boundary wall 74 closes off a lateral exterior of the proximal cavity 70 at the lateral side of the device that matches the distal jaws 54A, 54B and opposes the rocker arm 58 of the lock 16.

A transitional mid-segment 74C of the S-shaped boundary wall 74 connects the proximal and distal segments thereof. This mid-segment 74C is thicker than the other two segments, and accommodates penetrating receipt therethrough of a fastener 78 (e.g. rivet) that holds the two frame bodies 12A, 12B together in clamped relationship against one another. A distal end of the distal cavity 68 is closed off by a distal boundary wall 80 running along distal boundary edges of the outer walls 22A, 22B just beyond the distal ends of the release slots 30A, 30B, The distal boundary wall 80 runs along the distal end of the distal cavity 68 toward where the pivot pin 60 penetrates the distal corner shoulder 62 of the frame 12, but stops short of the pivot pin 60 in order to leave the distal outer corner of the distal cavity open and thereby accommodate the externally protruding distal portion of the rocker arm 58. This distal boundary wall 80 of the distal cavity 68 joins with a distal interior corner wall 82 that runs along the interior side of the distal chamber 68 toward the distal segment 74A of the S-shaped wall 74.

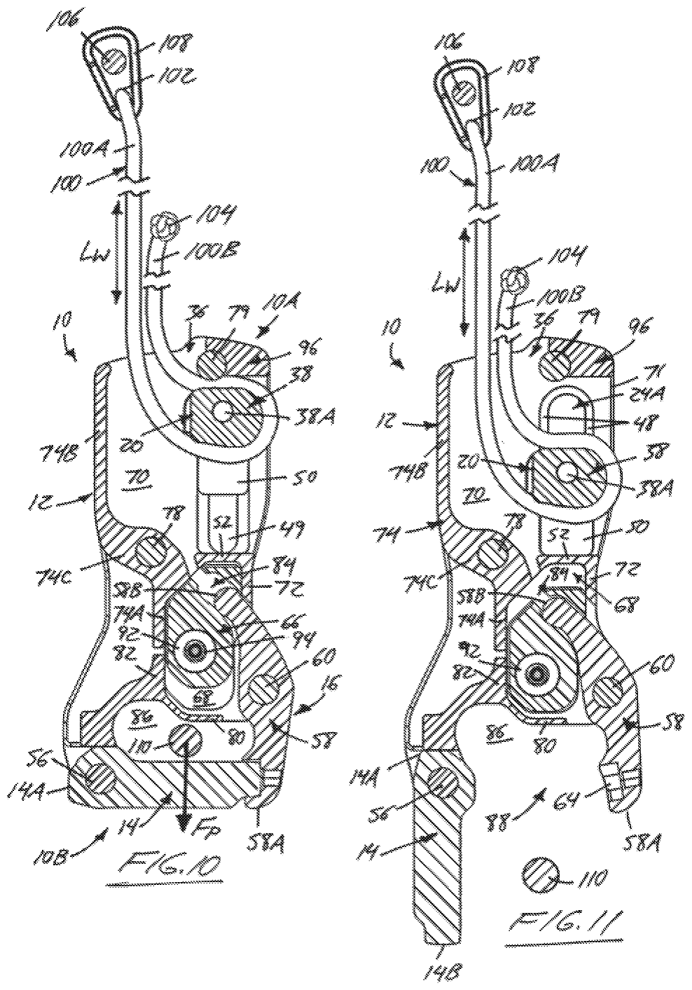

In the midplane of the device, and in other neighboring cross-sectional planes parallel thereto, the slider 66 of the quick release 18 release has a cross-sectional shape profile of similar shape but shorter longitudinal length than the distal cavity 68 in which it resides. This way, an exterior side of the slider 66 can slide longitudinally along the proximal exterior wall 72, while an interior side of the slider slides along the walls 74A, 82 at the opposing interior side of the distal cavity 68. The slider 66 is slidable within the distal cavity 68 between a default position abutting or closely adjacent the stop wall 52 at the proximal end of the distal cavity 68 (FIGS. 5 and 10), and a release position abutting or closely adjacent the distal boundary wall 80 at the distal end of the distal cavity 68. The slider 66 has a hollow rocker cavity 84 penetrating into the exterior side thereof near an exterior proximal corner of the slider (FIGS. 5 & 10), and a proximal end 58B of the rocker arm 58 is received in this rocker cavity 84 of the slider 66 for constrained movement therewith during sliding thereof. Longitudinal sliding of the slider 66 in the proximal direction toward the default position swings the proximal end 58B of the rocker arm outwardly about the second pivot pin 60, thereby swinging the opposing distal end 58A of the rocker arm inwardly for engagement with the free end 14B of the gate 14, when occupying its closed position spanning laterally from the jaws 54A, 54B toward the rocker arm 58. Longitudinal sliding of the slider 66 in the opposing distal direction toward the release position swings the proximal end 58B of the rocker arm inwardly about the second pivot pin 60, thereby swinging the opposing distal end 58A of the rocker arm outwardly away from the gate 14 to disengage the rocker arm's gate cavity 64 from the distal end 14B of the closed gate 14, whereafter the gate 14 is free to swing from its closed position to a distally extending open position shown in FIGS. 8, 9 and 11).

When the rocker arm 58 and the gate 14 are engaged together in their locking and closed positions, respectively, as can be seen in FIGS. 1-7 and 10, the engaged rocker arm 58 and gate 14 cooperate with the distal end of the frame 12 to form a closed structural boundary around an eye space 86 of the device 10, the purpose of which is to enable closed-hook engagement of the device 10 around a securement member 110 of an intended load that is to be cooperatively borne by the device 10 and lanyard 100. For example, this securement member may be a securement ring on an operator-worn belt or harness in instances where the load is a human operator of the device 10 and lanyard 100, for example in the helicopter lanyard context described above. So, when the rocker arm 58 and the gate 14 are engaged together in their locking and closed positions, respectively, the frame 12, closed gate 14, and gate-engaged rocker arm 58 cooperatively and fully enclose the eye space 86 and thereby capture the securement member 110 therein. However, when the rocker arm 58 is moved to its unlocking position via actuation of the quick release 18, the rocker arm 58 disengages from the free end 14B of the gate 14, allowing the gate 14 to swing open, and thus opening up a gap 88 between the jaws 54A, 54B and the retracted rocker arm 58 at a distal side of the eye space 86 to permit entry or exit of the securement member 110 thereto or therefrom (see FIGS. 8, 9 and 11) during coupling or decoupling of the load.

The slider 66 is equipped with two push-button actuators 90A, 90B respectively situated at the front and rear sides of the slider, with an inner end of each actuator 90A, 90B received in a through-bore 92 of the slider 66 that penetrates therethrough at a position placing its two open ends in respective alignment with the release slots 30A, 30B in the outer walls 22A, 22B of the frame 12. The actuators 90A, 90B have respective blind holes therein at the inner ends thereof, and a compression spring 94 has its two ends respectively disposed in these blind holes of the actuators 90A, 90B in order to normally bias the two actuators away from one another and outwardly from the shared through-bore 92 of the slider 66. Each push-button actuator 90A, 90B has a stepped diameter profile at its circumference. Each stepped diameter actuator 90A, 90B is characterized by a smallest diameter at an outer region of the actuator furthest from the midplane of the device, an intermediate diameter at a mid-region of the actuator closer to the midplane of the device, and largest diameter at an inner region of the actuator closest to the midplane of the device.

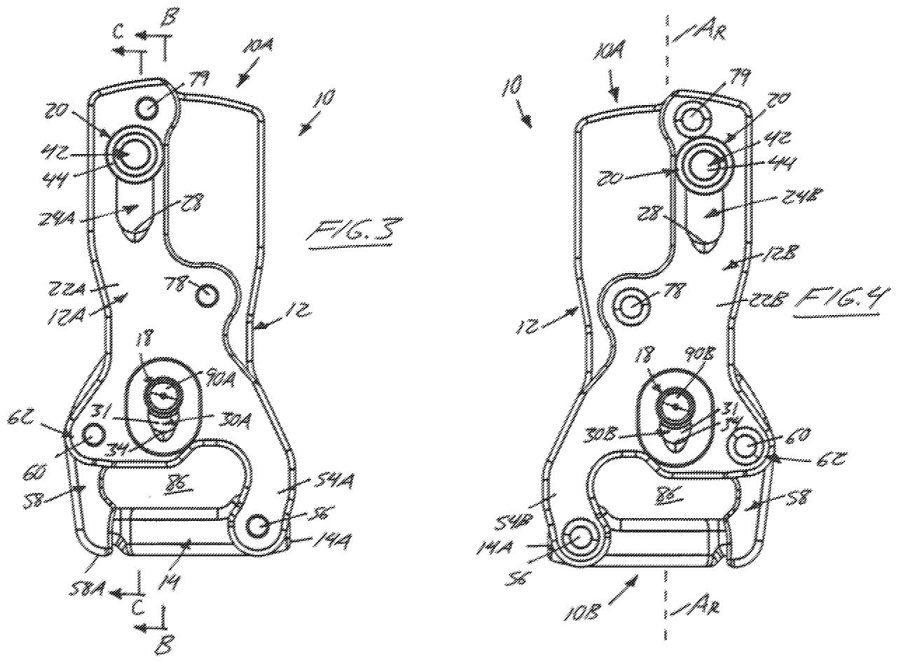

The release slots 30A, 30B in the outer walls 22A, 22B of the frame 12 are key-slot shaped, thus each having a proximal portion of the slot 29 (see FIG. 8) that is of greater width than a distal portion 31 of the slot (see FIG. 3 or 4). The outer region of each actuator 90A, 90B has a small enough diameter to fit within the width of the respective release slot's narrower distal portion 31, while the mid and inner regions of the actuator 90A, 90B are too large to fit therein. The mid-region of each actuator 90A, 90B is small enough in diameter to fit within the width of the respective release slot's wider proximal portion 29, while the largest diameter inner region of each actuator 90A, 90B is too large to fit in either portion of the respective release slot 30A, 30B, and thus is constrained to the interior space of the device.

In the default position of the slider 66, nearest to the proximal end of the distal cavity 68, the compression spring 94 biases the two push-button actuators 90A, 90B outwardly into positions where the intermediate diameter mid-regions thereof occupy the wider proximal portions 29 of the two release slots 30A, 30B. Here, the mid-regions of the push-button actuators 90A, 90B block sliding thereof into the narrower distal portions 31 of the release slots that are too narrow to accommodate these mid-regions of the push-button actuators 90A. 90B, whereby sliding displacement of the associated internal slider 66 in the distal direction is likewise prohibited, thus locking it in its default position. The quick release 18 is thus self-locking in its default position, which corresponds to the locking position of the rocker arm, where the distal end 14B of the closed gate is engaged by the rocker arm 58 to lock the gate in its closed position, thereby maintaining the closed state of the eye space 86. The only way that distal sliding of the internal slider 66 from its default position is enabled is by manual depression of both push-button actuators 90A, 90B inwardly toward one another, against the bias of the compression spring 94. Such simultaneous depression of the push-button actuators 90A, 90B displaces the intermediate diameter mid-regions of the two actuators into the interior space of the device 10 and out of the wider upper portions 29 of the release slots 30A, 30B, whereupon only the smallest diameter outer regions of the actuators 90A, 90B now occupy the narrower proximal portions 29 of the release slots, and can be manually pulled into the narrower distal portions 31 of the release slots 30A, 30B. This distal pulling of the depressed push-button actuators 90A, 90B slides the internal slider 66 distally toward the release position, which pivots the rocker arm 58 into its unlocking position, thus disengaging the rocker arm 58 from the distal end 14B of the gate 14, whereupon the gate 14 is freely movable into its open position.

The rocker arm 58 of the lock 16 is thus normally held in its locking position engaged with the closed gate 14, and the gate 14 and eye space 86 can only be opened by simultaneous manual actuation of the two push-button actuators 90A, 90B of the quick release 18 at the opposing front and rear sides of the device 10. This may be performed via single-handed squeezing of the actuators 90A, 90B together between the thumb and an opposing finger (e.g. pointer finger), in which case the operator's other hand remains free to perform other tasks. The preferred embodiment disclosed in the drawings affords even greater protection over inadvertent opening of the eye 86 of the device by requiring the additional third action, of having to pull the two now-depressed push-button actuators 90A, 90B distally along the release slots 30A, 30B to shift the slider 66 from its default lock-retaining position to its release position unlocking the rocker arm 58 from its normally locked engagement to the closed gate 14.

Having described the cooperative relationship between the gate 14, lock 16 and quick release 18, attention is now turned back to the slidable bollard 38 described earlier, whose purpose is to engage the overall connection device 10 to the lanyard 100, in a manner that will normally retain the device 10 at a particular location along the lanyard, yet be operable to selectively allow operator adjustment of this location in order to set the working length L_{W} of the lanyard to a suitable length. Referring to FIG. 11, the device 10 is installed on a lanyard 100 by feeding the tail end 104 of the lanyard 100 into the proximal cavity 70 of the device 10 via the lanyard opening 36 at the proximal end 10A of the device, with the bollard 38 slid distally away from the proximal ends 26 of the adjuster slots 24A, 24B. With the bollard so positioned, the tail end 104 of the lanyard 100 is fed distally through the proximal cavity 70 past the bollard 38, and then laterally across a distal side of the bollard 38 between the two slide tabs 50 and through an open exterior side 71 of the proximal cavity 70 that resides opposite the closed exterior side thereof bound by wall segment 74B. From this open exterior side 71 of the proximal cavity 70, the tail end 104 of the lanyard 100 is then fed back into the proximal cavity 70 across a proximal side of the bollard 38 between the bollard and the proximal clamping surfaces at 79, 96, and then proximally back through the lanyard opening 36. As shown in FIG. 11, the result is that an intermediate segment 100C of the lanyard 100, which joins the load and tail segments together inside the device 10, is wrapped circumferentially around the slidable bollard 38. The tail segment 100B feeds the proximal clamping side of the bollard and the load segment 100B feeds the opposing distal side thereof, and both the load segment 100A and tail segment 100B exit the device 10 via the shared lanyard opening 36 at the proximal end 10A thereof.

Referring to FIG. 10, when the coupler 108 of the lanyard 100 is attached to an anchor point 106, whenever a pulling force F_{P} acting in the longitudinally distal direction of the device 10 is exerted thereon at the gate-closed eye space 86 thereof by the eye-captured securement member 110 of the load, the pulling force F_{P} causes tensioning of the anchor-tethered loading segment 100A of the tether, and sliding of the bollard 38, relative to the frame 12, into a holding position adjacent the proximal ends 26 of the adjustment slots 24A, 24B, which acts to clamp the bollard-wrapped intermediate segment of the lanyard 100 in place between the bollard 38 and one or more proximally neighbouring clamping surfaces of stationarily fixed position on the frame 12. In the illustrated example, these clamping surfaces are defined by one or both of a proximal corner portion 96 of the frame 12 that resides at a proximal corner between the open lateral side 71 of the proximal cavity 70 and the lanyard opening 36 at the proximal end 10A of the frame 12, and/or another fastener 79 (e.g. rivet) that penetrates and fastens the two frame bodies 12A, 12B together near this proximal corner of the frame 12. In the illustrated embodiment, the round circumference of the fastener 79 forms a rounded clamping surface or friction post at an area where the lanyard turns a corner between the clamping space and the lanyard opening 36 to ensure a lack of sharp corners that could excessively pinch, cut or damage the lanyard.

Accordingly, the exertion of normally experienced pulling forces F_{P} on the device 10 serves to exert a clamped holding force on the lanyard 100 where it passes between the slidable bollard 38 and neighbouring clamping surface(s) at 96, 79. This holding force will prevent relative displacement between the device 10 and lanyard 100 to maintain the device's position on the lanyard. Even absent a pulling force F_{P} urging relative sliding of the bollard 38 toward a proximal holding position clamping the lanyard against the stationary clamping surface(s) at 96, 79, the wrapped state of the lanyard 100 in somewhat kinked fashion around the slidable bollard 38 nonetheless provides sufficient frictional hold therebetween to maintain a generally static position of the device along the lanyard so as not to significantly effect the current working length L_{W} of the lanyard. During engineer of its design, the length adjuster can also be tuned, relative to the specifications of a prescribed lanyard to be used with the device, to allow some intentional slippage to occur between the bollard and the clamping surface during atypical pulling forces that exceeds a certain threshold, thus providing a shock absorption function during such instances of excess load forces.

When adjustment of the lanyard's working length L_{W} is desired, the operator intentionally and manually slides the bollard 38, via gripping of one or both of its exterior caps 42, toward the distal ends 28 of the adjuster slots 24A, 24B to an adjustment position that opens up a larger gap between the bollard 38 and the clamping surface(s) at 96, 79 on the proximal side of the bollard 38, as shown in FIG. 11. A similar open gap is automatically left open on the distal side of the bollard 38 in this adjustment position, owing to abutment of the distally projecting slide tabs 50 against the stop surface 52 at the distal ends of the extension recesses 49 of the adjuster slots 24A, 24B. Manual pulling of the load or tail segments 100A, 100B of the lanyard 100, optionally after manually loosening the kinked/wrapped state of the lanyard 71 around the bollard 38 at the open side of the proximal cavity 70, can then be performed to adjust the working length L_{W} of the lanyard 100.

It will be appreciated that though the combination of a length adjuster 20 and an openable, closable and lockable load connecting eye 86 into a singular piece of hardware is particularly novel and beneficial, it will also be appreciated that the novel quick-release mechanism 18 for the load connecting eye 86 may be put to similar beneficial use in a connection device lacking a built-in length adjustor 20, including connection devices that don't necessary use a lanyard 100, and instead use another variety of rope, cable, or otherwise flexible line. Likewise, the novel sliding-bollard length adjuster 20 may be employed in a stand-alone length adjustor lacking a load connection eye. It will also be appreciated that though the novel device disclosed herein was developed particularly to address shortcomings in the field of helicopter lanyards, the teachings of the present invention may be similarly applied to any variety of applications involving the tethering, hoisting or other manipulations of a load.

Since various modifications can be made in my invention as herein above described, and many apparently widely different embodiments of same made, it is intended that all matter contained in the accompanying specification shall be interpreted as illustrative only and not in a limiting sense.

1. A lanyard connection device for combined use with a lanyard having an anchoring end equipped with a coupler for anchored attachment to an anchor point, and an opposing tail end, said connection device comprising a singular assembly whose components comprise:
a frame;
a gate movably supported on the frame and movable relative thereto between a closed position in which said gate cooperates with at least one other of the components to collectively form a closed boundary around an eye space, and an open position that opens up a gap in said closed boundary to enable insertion of a securement member of an intended load into the eye space such that reclosure of the gate secures said intended load to the device;
a lock movably supported on the frame and movable relative thereto between a locking position engaging and holding the gate in the closed position, and an unlocking position disengaged form the gate to allow movement thereof to the open position;
a quick release operably associated with the lock to normally hold the lock in the locking position, absent user-actuation of said quick-release; and
a length adjuster configured for engagement with the lanyard at an intermediate region thereof between the anchoring and tail ends thereof, and manipulatable between a holding state imparting a hold between the device and the lanyard to prevent relative displacement therebetween, and an adjustment state releasing said hold to allow said displacement, thereby enabling adjustment of a working length of the lanyard between the anchoring end thereof and the device.

2. The device of claim 1 where the lock comprises a rocker arm pivotably mounted to the frame and pivotable between said locking and unlocking positions.

3. The device of claim 1 wherein the quick release comprises a slider slidably coupled to the frame and displaceable back and forth relative thereto along a slide path from a default position holding the lock in the locking position, toward a release position.

4. The device of claim 3 wherein a portion of the lock is constrained to the slider for movement therewith back and forth along the slide path.

5. The device of claim 2 wherein the quick release comprises a slider slidably coupled to the frame and displaceable back and forth relative thereto, and one end of the rocker arm is constrained to the slider for movement therewith back and forth along the slide path.

6. The device of claim 3 wherein the slider comprises two push-button actuators that reside at opposing sides of the slider in normally undepressed positions that lock the slider in the default position, and are depressible to depressed positions allowing displacement of the slider from the default position toward the release position.

7. The device of claim 1 wherein the quick release comprises multiple actuators that require simultaneous actuation to release the lock from the locking position.

8. The device of claim 7 wherein said multiple actuators comprise two actuators disposed at opposing sides of the device.

9. The device of claim 8 wherein said two actuators comprise two push-button actuators that require simultaneous depression toward one another to release the lock from the locking position.

10. The device of claim 1 wherein the length adjuster is configured to automatically engage itself in the holding state under application of a pulling load to the device at the eye space thereof.

11. The device of claim 1 wherein the length adjuster comprises a slidable bollard slidably coupled to the frame and displaceable back and forth relative thereto between a holding position clamping the intermediate region of the lanyard against a stationary feature on the frame to impart said hold, and an adjustment position withdrawn further away from said stationary feature to release said hold.

12. The device of claim 11 wherein the sliding bollard is slidable back and forth on a bollard slide path that runs in a longitudinal direction of the device in which the sliding bollard and the bollard slide path are also spaced from the eye space, and the stationary feature of the frame resides near an end of the bollard slide path furthest from the eye space, such that exertion of a longitudinal pulling load on the device at the eye space thereof in a pulling direction away from the sliding bollard acts to automatically clamp the lanyard against the stationary feature.

13. The device of claim 12 comprising a lanyard opening for accommodating routing of the lanyard to and around the sliding bollard, wherein the lanyard opening and the eye space reside distally opposite one another in said longitudinal direction of the device.

14. The device of claim 1 wherein the length adjuster is configured to intentionally allow limited slippage between the device and the lanyard under application of a shock load that exceeds a predetermined limit.

15. The device of claim 7 wherein the multiple actuators are configured to require performance of multiple and distinct actuating movements thereon to actuate the quick release.

16. A connection device for connecting a load to a flexible line, said device comprising a singular assembly whose components comprise:
a frame;
a line engagement component for receiving said flexible line and holding the device thereto;
a gate movably supported on the frame and movable relative thereto between a closed position in which said gate cooperates with at least one other of the components to collectively form a closed boundary around an eye space, and an open position that opens up a gap in said closed boundary to enable insertion of a securement member of an intended load into the eye space such that reclosure of the gate secures said intended load to the device;
a lock movably supported on the frame and movable relative thereto between a locking position engaging and holding the gate in the closed position, and an unlocking position disengaged from the gate to allow movement thereof to the open position; and
a quick release operably associated with the lock to normally hold the lock in the locking position, absent user-actuation of said quick-release;
wherein the quick release comprises multiple actuators that require simultaneous actuation thereof to release the lock from the locking position.

17. The device of claim 16 wherein said multiple actuators comprise two actuators disposed at opposing sides of the device.

18. The device of any claim 16 wherein the quick release comprises a slider slidably coupled to the frame and displaceable back and forth relative thereto along a slide path from a default position holding the lock in the locking position, toward a release position.

19. The device of claim 16 wherein the multiple actuators are configured to require performance of multiple and distinct actuating movements thereon to actuate the quick release.

20. A length adjustment device for combined use with a lanyard having an anchoring end equipped with a coupler for anchored attachment to an anchor point, and an opposing tail end, said length adjustment device comprising:
a frame; and
a slidable bollard for wrapped engagement thereof by the lanyard at an intermediate region thereof between the anchoring and tail ends of said lanyard, said slidable bollard being slidably coupled to the frame and displaceable back and forth relative thereto between a holding position clamping the intermediate region of the lanyard against a stationary feature on the frame to impart a hold between the device and the lanyard to prevent relative displacement therebetween, and an adjustment position withdrawn further away from said stationary feature to release said hold and allow said displacement, thereby enabling adjustment of a working length of the lanyard between the anchoring end thereof and the device.
